(19) United States
(12) Patent Application Publication
(10) Pub. No.: US 2011/0268172 A1
(43) Pub. Date: Nov. 3, 2011

(54) RECEIVER APPARATUS AND RECEIVING METHOD

(75) Inventors: Takaya Hayashi, Kyoto (JP); Tetsuya Yagi, Osaka (JP)

(73) Assignee: Panasonic Corporation, Osaka (JP)

(21) Appl. No.: 13/129,457

(22) PCT Filed: Dec. 9, 2009
(86) PCT No.: PCT/JP2009/070623

§ 371 Date: Jul. 19, 2011

(30) Foreign Application Priority Data
Dec. 12, 2008 (JP) 2008-317201

(51) Int. Cl. H04L 27/00; H04B 1/18

(52) U.S. Cl. 375/229; 375/316

(57) ABSTRACT

There is disclosed a receiver apparatus that can receive OFDM signals. The apparatus comprises: an FFT unit for transforming signals inputted to the apparatus into frequency-domain signals, thereby outputting the transformed signals on a complex symbol-by-complex symbol basis; correlation-calculating units each of which calculates an index indicating a correlation between complex symbols in a respective one of a plurality of groups, each of the plurality groups being a set of a plurality of complex symbols separated from each other by an interval in which a pilot signal is inserted, the groups being selected such that the complex symbols constituting the groups differing from each other; and a judging unit for determining, based on the calculated index for each group, whether or not any index satisfying a predetermined condition is existent, thereby outputting a result of the judgment.

### TECHNICAL FIELD

The present invention relates to a receiver apparatus and a receiving method for rapidly judging whether or not inputted signals are OFDM signals with high precision.

### BACKGROUND ART

There are transmission methods using the OFDM (Orthogonal Frequency Division Multiplexing) signals for digital terrestrial television services in Japan, Europe and South America. In Japan, not only non-portable receiver apparatuses but also mobile terminals and car-mounted terminals receive digital terrestrial television services.

In general, a channel selected from a plurality of channels is sequentially changed within a predetermined range, a channel in which the OFDM signals exist is judged, and the judged channel of the OFDM signals is stored/set up in a receiver apparatus when receiving the digital terrestrial television services. Hereinafter, a series of the operation is called a “channel search”.

The channel search should preferably detect rapidly whether or not the OFDM signals exist in the selected channel with sufficient precision regardless of receiving environment affected by various transmission paths. Document 1 discloses such technique with respect to the channel search.
[Document 1] Published Japanese patent application Laid-open No. 2007-318638

### DISCLOSURE OF INVENTION

### Problem(s) to be Solved by Invention

Document 1 discloses technique that uses AC carriers and TMCC carriers which are included in OFDM signals so as to judge whether or not OFDM signals exists in a selected channel when performing the channel search.

In case of Mode 3 of the ISDB-T (Integrated Services Digital Broadcasting-Terrestrial) standard, which is Japanese transmission standard of digital terrestrial television services, one OFDM signal is composed of 5617 carriers per channel. The carriers include: 104 carriers (hereinafter, “AC carriers”) transmitting AC (Auxiliary Channel: channel for transmitting addition information) signals; and 52 carriers (hereinafter, “TMCC carriers”) transmitting TMCC (Transmission and Multiplexing Configuration Control) signals.

In the ISDB-T standard, transmission bandwidth of one channel is divided into thirteen segments, a center segment of which can be used for so-called “one segment broadcasting” that performs transmission for receiving signals with an automobile or a portable device. Receiver apparatuses for one segment broadcasting only receive the one segment of the center bandwidth. The one segment of the center bandwidth includes: eight AC carriers; and four TMCC carriers, respectively. The number of AC carriers and TMCC carriers is remarkably less than the number of whole carriers.

Since the receiver apparatus recited in Document 1 uses AC carriers and TMCC carriers in order to detect OFDM signals, receiving power of the carriers may be easily reduced and/or may be damaged, thereby precision of detecting the OFDM signals may be deteriorated caused by poor reception power of the carriers and/or a frequency position where disturbance occurs. These phenomena become remarkably serious when using the receiver apparatus that receives the one segment broadcasting with a less carrier number. As a result, there is a problem that a channel to be judged as a channel capable of receiving OFDM signals may be erroneously judged, or that time to generate a judgment result may become longer.

In view of the above, an object according to the present invention is to provide by low cost a receiver apparatus and a receiving method for performing rapid judgment of receiving desired signals with high precision even when the situation of transmission paths is inferior.

### Means for Solving Problem(s)

In order to solve the above problems, there is provided a receiver apparatus capable of receiving OFDM signals in which pilot signals with a predetermined amplitude and a predetermined phase are inserted at a predetermined time interval or a frequency interval to be transmitted, the receiver apparatus comprising: a Fourier transforming unit operable to transform signals inputted to the receiver apparatus to frequency-domain signals, thereby outputting the transformed signals on a complex symbol-by-complex symbol basis; an index calculating unit operable to calculate an index indicating a correlation between complex symbols in a respective one of a plurality of groups, each of the plurality of groups being a set of a plurality of complex symbols separated from each other by an interval in which a pilot signal is inserted, the group being selected such that the complex symbols constituting the groups differing from each other; a judging unit operable to judge, based on the calculated index for each group, whether or not any index satisfying a predetermined condition is existent, thereby outputting a result of the judgment; and a processing unit operable to judge whether or not the signals inputted to the receiver apparatus are OFDM signals according to the result of the judgment of the judging unit.

### Effect of Invention

When performing a channel search, the simple arrangement of the receiver apparatus according to the present invention enables to rapidly judge whether or not OFDM signals exist in a selected channel with high precision.

In addition, the receiver apparatus according to the present invention can especially improve judgment precision when receiving one segment broadcasting with a less carrier number.

### BRIEF DESCRIPTION OF DRAWINGS

FIG. 1 is a block diagram of a receiver apparatus of Embodiment 1 according to the present invention,

FIG. 2 is an illustration of a transmission format of OFDM signals that the receiver apparatus according to the present invention receives,

FIG. 3 is a block diagram of an SP detecting unit 106 in Embodiment 1 according to the present invention,

FIG. 4 is a block diagram of a group in the OFDM signals of Embodiment 1 according to the present invention,

FIG. 5 is an illustration of the OFDM signals in the SP detecting unit of Embodiment 1 according to the present invention,

FIG. 6 is a block diagram of a judging unit 305 of Embodiment 1 according to the present invention,

FIG. 7 is a block diagram of a judging unit 305B of Embodiment 1 according to the present invention,

FIG. 8 is a time chart illustrating operation of the judging unit 305B of Embodiment 1 according to the present invention,

FIG. 9 is a flowchart of a channel search performed by the receiver apparatus according to the present invention,

FIG. 10 is a block diagram of a receiver apparatus of Embodiment 2 according to the present invention,

FIG. 11 is a block diagram of an SP detecting unit 106B in Embodiment 2 according to the present invention, and

FIG. 12 is a block diagram of a group in OFDM signals of Embodiment 2 according to the present invention.

### DESCRIPTION OF SYMBOLS

101: Antenna
102: Tuner
103: Orthogonal Detecting Unit
104: FFT Unit
105: Equalizer
106: SP Detecting Unit
107: Control Unit
108: Error Correcting Unit
109: Back End Unit
110: Outputting Unit
111: CPU
112: Memory

### BEST MODE FOR CARRYING OUT THE INVENTION

### Embodiment 1

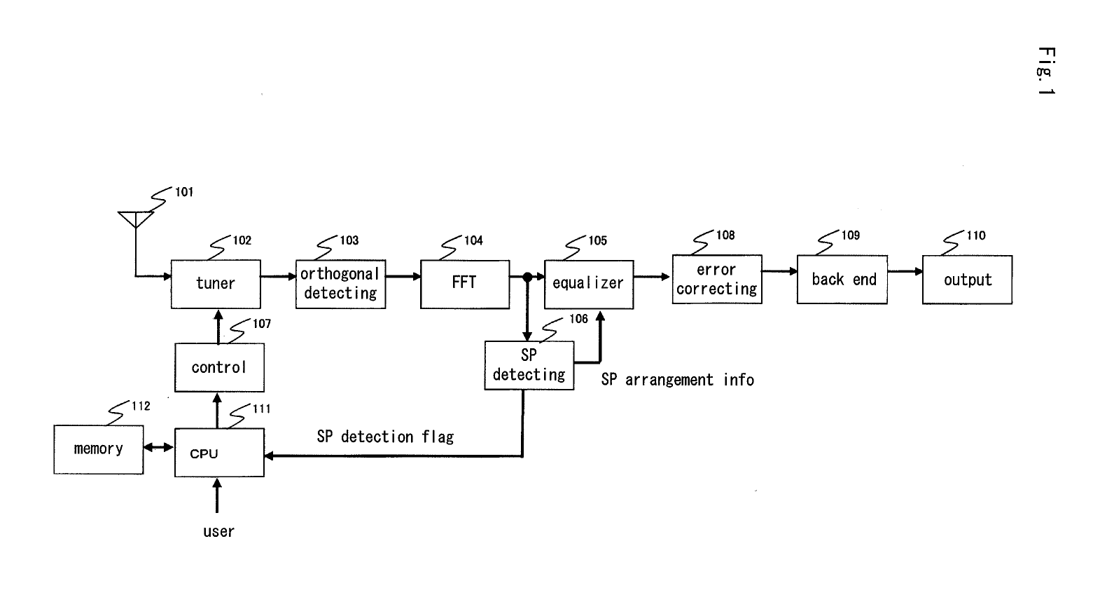

FIG. 1 is a block diagram of a receiver apparatus of Embodiment 1 according to the present invention. In FIG. 1, an antenna 101, a tuner 102, an orthogonal detecting unit 103, an FFT unit 104, an equalizer 105, an SP detecting unit 106, a control unit 107, an error correcting unit 108, a back end unit 109, an outputting unit 110, a CPU 111, and a memory 112 are shown, respectively.

Operation of each element will now be explained. The antenna 101 receives OFDM signals of transmitted RF (Radio Frequency) bandwidth, and outputs received the OFDM signals to the tuner 102.

The tuner 102 selects OFDM signals of predetermined (channel) frequency bandwidth from the OFDM signals of the RF bandwidth inputted from the antenna 101 based on a channel selecting signal instructed by the control unit 107, performs frequency transformation thereon, obtains OFDM signals of IF (Intermediate Frequency) bandwidth, and outputs the obtained OFDM signals to the orthogonal detecting unit 103.

The orthogonal detecting unit 103 performs orthogonal detection on the OFDM signals of the IF bandwidth (frequency transformation into the base band), generates OFDM signals of a time-domain according to a complex format having an I-axis component and a Q-axis component, and outputs the generated OFDM signals to the FFT unit 104.

The FFT unit 104 performs fast Fourier transformation on the OFDM signals of the time-domain, generates OFDM signals of a frequency-domain, and outputs the generated OFDM signals to the equalizer 105 and the SP detecting unit 106.

The equalizer 105 specifies, based on SP arrangement information from the SP detecting unit 106, a position of an SP (Scattered Pilot) signal, estimates a status of transmission paths according to the specified SP signal, performs compensation of complicated waveform distortion of the received signals using the estimated status (so-called “waveform equalization”) to generate equalized signals, and outputs the equalized signals to the error correcting unit 108.

The SP detecting unit 106 detects the existence of SP signals in the OFDM signals of the frequency-domain, and outputs a result thereof to the CPU 111 as an SP detection flag. The SP detecting unit 106 also outputs a signal indicating SP arrangement information to the equalizer 105.

The control unit 107 assigns a channel to be received according to the selecting instruction from the CPU 111, and outputs the assigned channel to the tuner 102 as a channel selecting signal.

The CPU 111 possesses a various kinds of functions, upon receiving an instruction from a user, generates a channel selection instruction signal for selecting a channel, and outputs the generated signal to the control unit 107. The CPU 111, upon receiving from another instruction, performs a channel search, outputs a channel selection instruction signal to the control unit 107, judges whether or not OFDM signals (or desired signals) exist in a selected channel according to a value of an SP detection flag obtained from the SP detecting unit 106, and outputs results of the processing onto the memory 112 for every channel. The channel information stored on the memory 112 is also used when selecting a channel.

The memory 112 is controlled by the CPU 111 and stores information, for every channel, indicating whether or not OFDM signals (presented by digital terrestrial television services) can be received after a channel search.

The error correcting unit 108 performs various kinds of error correction processes, such as de-interleaving, Viterbi decoding, and Reed-Solomon decoding, or the like on equalized signals inputted from the equalizer 105, and outputs a correction result to the back end unit 109 as a TS (transport stream).

The back end unit 109 performs MPEG decoding processes, such separating and/or expanding information source signals of, such as video items and audio items, from the transport stream inputted from the error correcting unit 108, reproduces and outputs the video, audio and other items of digital data to the outputting unit 110.

The outputting unit 110 may be a display monitor that displays the video items from the back end unit 109, a loudspeaker that sounds according to the audio items, or an external output terminal for outputting the digital data.

Concrete operation of the receiver apparatus constituted as mentioned above will now be explained using an example that OFDM signals corresponding to the ISDB-T standard are received.

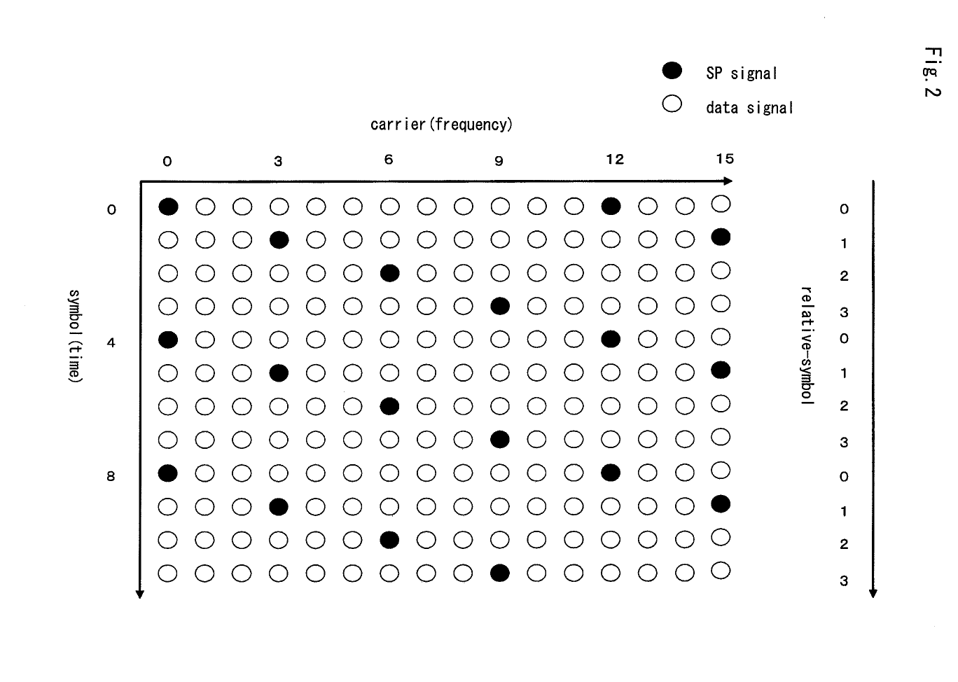

FIG. 2 is an illustration of a transmission format of OFDM signals that the receiver apparatus of the present invention receives. In FIG. 2, the left vertical axis (time axis) indicates symbol numbers, the horizontal axis (frequency axis) indicates carrier numbers, respectively. White circles show data carriers storing data signals for transmitting video and audio items of information. The data signals have been modulated according to 64QAM, QPSK, or the like. Black circles in FIG. 2 show pilot signals, and illustrate SP signals in the ISDB-T standard here. The SP signals are a kind of pilot signals used as the criteria of decoding operation, have been inserted to estimate effects of multipaths occurred in transmission paths. This is because it is necessary for a receiving side to estimate transmission path characteristics. The inserted points, amplitude, and phase of the SP signals are predetermined. For example, inserted points of SP signals with a carrier number “0” are positions of symbol numbers of “0, 4, 8, and . . . ”.

As shown in FIG. 2, in case of the ISDB-T standard, one of the SP signals is inserted per four pieces in the direction of the time axis (symbol direction), and is inserted per twelve pieces in the direction of the frequency axis (carrier direction), respectively. This arrangement is repeated in a cycle of four symbols.

For simple explanation, in order to distinguish symbols in the cycle of four symbols, numbers of “0, 1, 2 and 3” of “relative symbols” are added like the right vertical axis of FIG. 2. The numbers of “0, 1, 2 and 3” correspond to the arranged positions of the SP signal, respectively.

Namely, as shown in FIG. 2, definition is made as follows:

symbols whose SP signals are arranged at the positions of carrier numbers of “0, 12, . . . ” have a relative-symbol of “0”;

symbols whose SP signals are arranged at the positions of carrier numbers of “3, 15, . . . ” have a relative-symbol of “1”;

symbols whose SP signals are arranged at the positions of carrier numbers of “6, 15, . . . ” have a relative-symbol of “2”; and

symbols whose SP signals are arranged at the positions of carrier numbers of “9, 18, . . . ” have a relative-symbol of “3”.

In Mode 3 of the ISDB-T standard, one symbol is composed of 5617 carriers, and one frame is composed of 204 symbols. After having detected a frame synchronization signal transmitted by TMCC signals inserted at predetermined carrier positions (not shown), and then symbol numbers of “0, 1, . . . , and 203” corresponding to symbols constituting the frame are specified.

From the FFT unit 104, a plurality of signals included in every symbol as shown in FIG. 2 as OFDM signals of a frequency-domain are acquired, and each of the plurality of signals is of a complex format having an I-axis component and a Q-axis component, respectively. Hereinafter, complex signals contained by each carrier shown with a white circle or a black circle in FIG. 2 will now be called “complex symbols”.

Next, the SP detecting unit 106 will now be explained. The SP synchronous detecting unit detects the existence of SP signals based on a correlation degree between complex symbols the same distance away from each other as the distance of two adjoining SP signals.

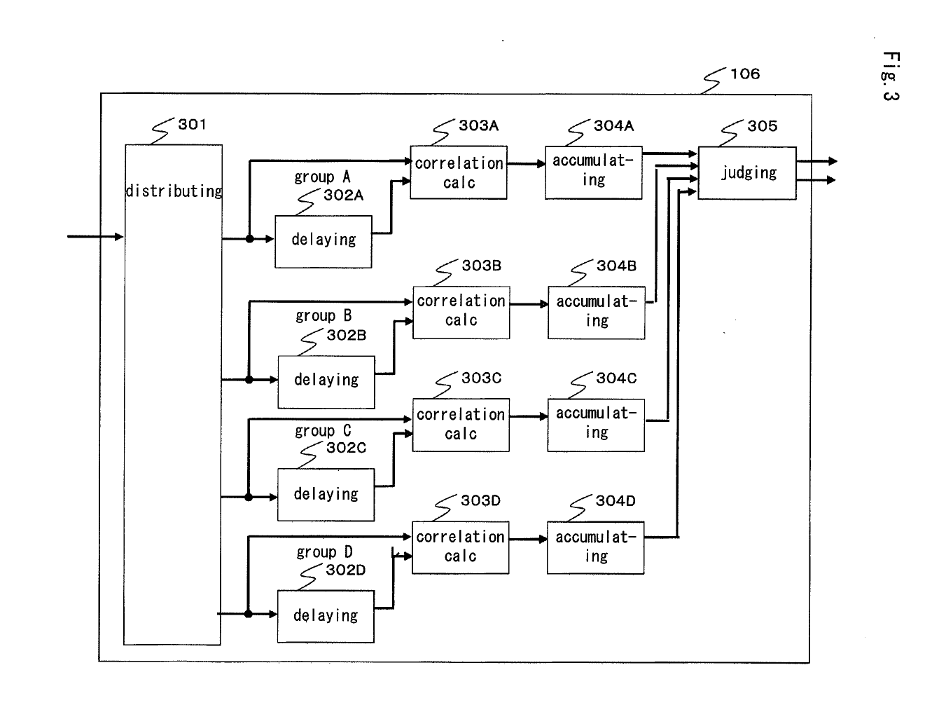

FIG. 3 is a block diagram of an SP detecting unit in Embodiment 1 according to the present invention. In FIG. 3, a distributing unit 301, delaying units 302A, 302B, 302C and 302D, correlation calculating units 303A, 303B, 303C and 303D, accumulating units 304A, 304B, 304C and 304D, and a judging unit 305 are shown, respectively.

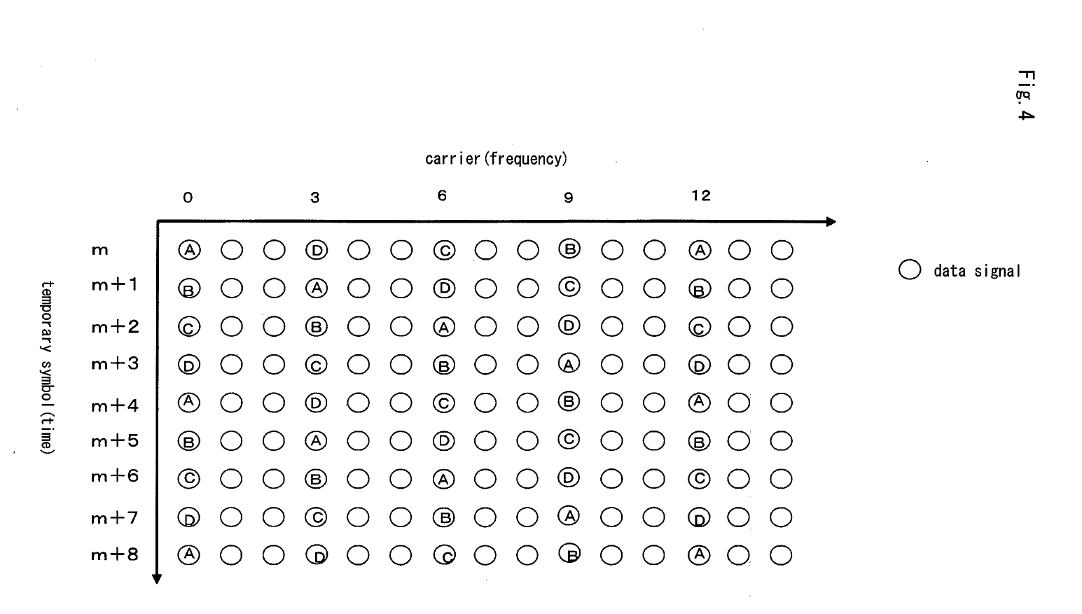

Immediately after beginning receiving operation until a frame synchronization signal has been detected, symbol numbers of receiving signals cannot be determined. In this state, OFDM signals of a frequency-domain as shown in FIG. 4 are inputted to the SP detecting unit 106. As shown in FIG. 4, symbol numbers of the vertical axis cannot be determined (for explanation, temporary symbol numbers of “m, m+1, . . . ” are temporarily added). Although carriers that SP signals are inserted therein are known, it is assumed that inserted symbols are unknown. Herein, complex symbols belonging to one of the groups A, B, C, and D shown in FIG. 4 transmit SP signals. The group A means a set of a plurality of complex symbols labeled the symbol of “A”. Similarly, the group B means a set of a plurality of complex symbols labeled the symbol of “B,” the group C means a set of a plurality of complex symbols labeled the symbol of “C,” and the group D means a set of a plurality of complex symbols labeled the symbol of “D,” respectively. Complex symbols are different from each other between the groups A, B, C, and D.

As apparent from FIG. 2, the number “4” of this group is obtained based on the number “4” of a carrier in which SP signals may be inserted among twelve carriers that agree, considering one certain symbol in the carrier direction, with an insertion interval of SP signals. For example, it is preferable to provide with four groups in order to detect existence of SP signals when it is known that SP signals are transmitted by four carriers of carrier numbers of “0, 3, 6 and 9” among twelve carriers of carrier numbers of “0, 1, . . . , and 11”.

The distributing unit 301 extracts complex symbols belonging to group

A from inputted OFDM signals of a frequency-domain, and outputs the extracted complex symbols to the delaying unit 302A and the correlation calculating unit 303A. Similarly, the distributing unit 301 extracts complex symbols belonging to group B, group C, and group D, and outputs the extracted complex symbols to the delaying units 302B, 302C, and 302D and the correlation calculating units 303B, 303C, and 303D, respectively.

The delaying units 302A, 302B, 302C, and 302D perform delay process of four symbols, which agree with the insertion intervals of SP signals on the inputted complex symbols, and output the delayed complex symbols to the corresponding one of the correlation calculating units 303A, 303B, 303C, and 303D, respectively.

The correlation calculating unit 303A calculates a correlation value between a complex symbol inputted from the distributing unit 301 and a complex symbol obtained from the delaying unit 302A, and outputs a calculation result to the accumulating unit 304A. Similarly, the correlation calculating units 303B, 303C, and 303D calculate correlation values between complex symbols inputted from the distributing unit 301 and complex symbols obtained from the delaying units 302B, 302C, and 303D, and outputs calculation results to the accumulating units 304B, 304C, and 304D, respectively.

For example, in FIG. 4, the correlation calculating unit 303A calculates a correlation value between a complex symbol of a temporary symbol number “m” and a carrier number “0” and a complex symbol of a temporary symbol number “m+4” and a carrier number “0”, and outputs a result to the accumulating unit 304A. Then, the correlation calculating unit 303A calculates a correlation value between a complex symbol of a temporary symbol number “m” and a carrier number “12” and a complex symbol of a temporary symbol number “m+4” and a carrier number 12, and outputs a result to the accumulating unit 304A. Similar to the above, the correlation calculating unit 303A calculates a correlation value between a complex symbol of a temporary symbol number “m” and a complex symbol of a temporary symbol number “m+4” for every set of twelve carriers, and outputs a result thereof to the accumulating unit 304A. The correlation calculating unit 303A has calculated all of correlation values between a complex symbol of a temporary symbol number “m” and a complex symbol of a temporary symbol number “m+4”, and then the correlation calculating unit 303A calculates correlation values between a complex symbol of a temporary symbol number “m+1” and a carrier number “3” and a complex symbol of a temporary symbol number “m+5” and a carrier number “1”, and outputs a result thereof to the accumulating unit 304A. Similar to the above, the correlation calculating unit 303A calculates correlation values of complex symbols corresponding to the positions “A” whenever the complex symbols corresponding to the positions “A” are inputted. Similar to the correlation calculating unit 303A, the correlation calculating units 303B, 303C, and 303D calculate correlation values of groups B, C, and D, respectively.

It is enough for the correlation calculating units 303A, 303B, 303C, and 303D to use a correlation value calculating method that earns an index indicating a correlation degree between two inputted signals. For example, the units may transform one of the two inputted signal into a complex conjugate, and then may perform complex multiplication of the complex conjugate and the other of the two inputted signals, that is, may perform complex conjugate multiplication.

Alternatively, the correlation value calculating method of the correlation calculating units 303A, 303B, 303C, and 303D may include: converting one of the two inputted signal into a complex conjugate; performing complex multiplication of the complex conjugate and the other of the two inputted signals (complex conjugate multiplication); and multiplying a result of the complex conjugate multiplication by itself. In the DVB-T2 standard, phases of SP signals, even if they are transmitted by the same carrier, differ for every symbol, and may take either a value of “0” or a value of “pi”. The multiplying the result of the complex conjugate multiplication by itself enables to solve uncertainty that a pair of complex symbols, which are used when calculating a correlation value of a pair of complex symbols, may have an anti-phase or the same phase, thereby calculating an appropriate correlation value.

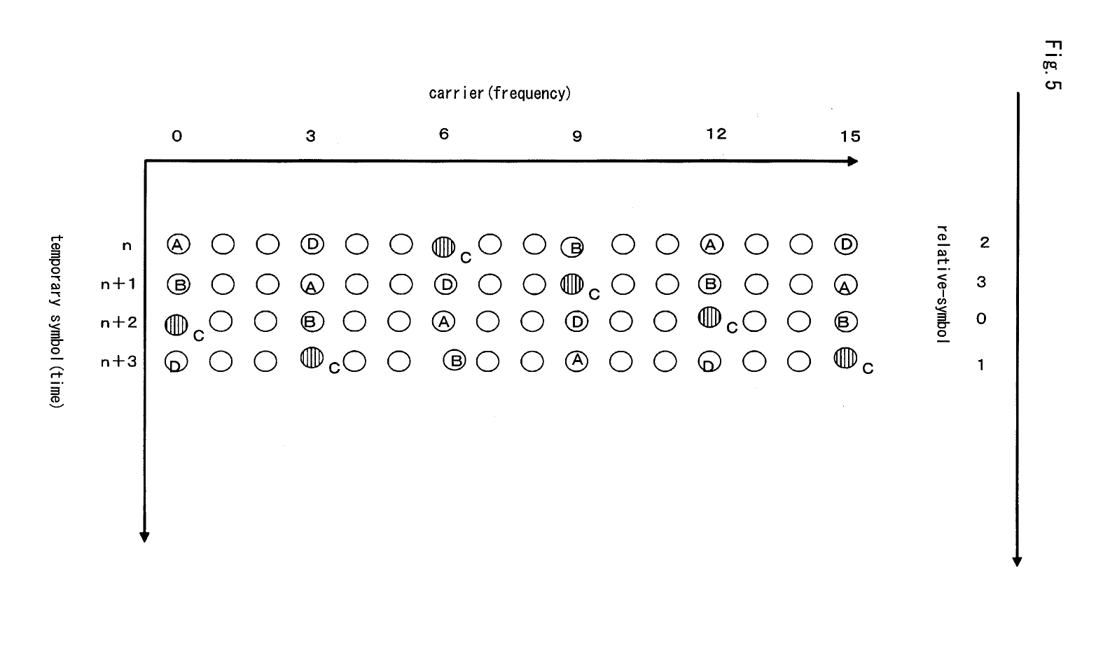

When obtaining a correlation value of two complex symbols, a correlation degree of complex symbols located at white circles (data signals) in FIG. 2 becomes less, because the complex symbols contain randomly modulated information such as video items and/or audio items. On the contrary, a correlation value of complex symbols located at black circles (SP signals) that are four symbols away in the frequency axis in the same carrier has a higher value. This is because SP signals transmitted by the same carrier on the frequency axis have the same amplitude and the same phase according to the ISDB-T standard, the DVB-T standard used in European digital terrestrial television services, or the like. Correlation values obtained by a correlation calculating unit corresponding to a group transmitting SP signals are greater than correlation values obtained by correlation calculating units corresponding to the other groups. For example, as shown in FIG. 5, when SP signals are transmitted at the hatched circle positions, correlation values of complex symbols located at thus hatched positions are greater than correlation values of the other complex symbols, and the hatched positions are shifted for three carriers per symbol.

The accumulating unit 304A accumulates a correlation value inputted from the correlation calculating unit 303A, and outputs an accumulated result to the judging unit 305 as an accumulative value. Similarly, the accumulating units 304B, 304C, and 304D accumulate inputted correlation values, and output accumulated results to the judging unit 305 as an accumulative value, respectively.

For example, in FIG. 4, the accumulating unit 304A accumulates correlation values obtained at positions of complex symbols of carrier numbers of “0, 12, . . . ” when a temporary symbol number is “m+4”, accumulates correlation values obtained at positions of complex symbols of carrier numbers of “3, 15, . . . ” when a temporary symbol number is “m+5”. Similarly, the accumulating unit 304A accumulates correlation values whenever the correlation values correspond to the position “A”. Accumulating accumulative values with respect to groups B, C, and D is similarly performed, as mentioned-above.

The accumulating method of the accumulating units may include:

accumulating inputted correlation values with respect to a carrier direction and a symbol direction to output a first accumulated result; and calculating the sum of the square of an I-axis component and the square of a Q-axis component of the first accumulated result as first power, or

accumulating inputted correlation value per symbol with respect to the carrier direction to output a second accumulated result; calculating the sum of the square of an I-axis component and the square of a Q-axis component of the second accumulated result as second power per symbol; and accumulating the second power per symbol with respect to the symbol direction, or the like.

The accumulative values are indexes indicating correlation degrees between complex symbols in each group, and accumulative values corresponding to a group transmitting SP signals are remarkably greater than accumulative values corresponding to the other groups. In FIG. 5, accumulative results obtained with respect to group C are greater than those of the other groups.

When accumulative values inputted from the accumulating units 304B, 304C, and 304D satisfy a predetermined condition, the judging unit 305 outputs an SP detection flag meaning that SP signals have been detected to the control unit 107. Furthermore, based on a group whose inputted accumulative values are the maximum, the judging unit 305 determines current relative-symbol number shown in FIG. 2, and outputs the determined number to the equalizer 105 as SP arrangement information.

Herein, how the judging unit 305 judges whether SP signals are detected will now be explained. It is assumed that accumulative values obtained from the accumulating units 304A, 304B, 304C, and 304D are an accumulative value “accA”, an accumulative value “accB”, an accumulative value “accC”, and an accumulative value “accD”, respectively. It is also assumed that a value of the SP synchronization flag shall be set to “1” when the SP signals are not detected, or otherwise to “0”.

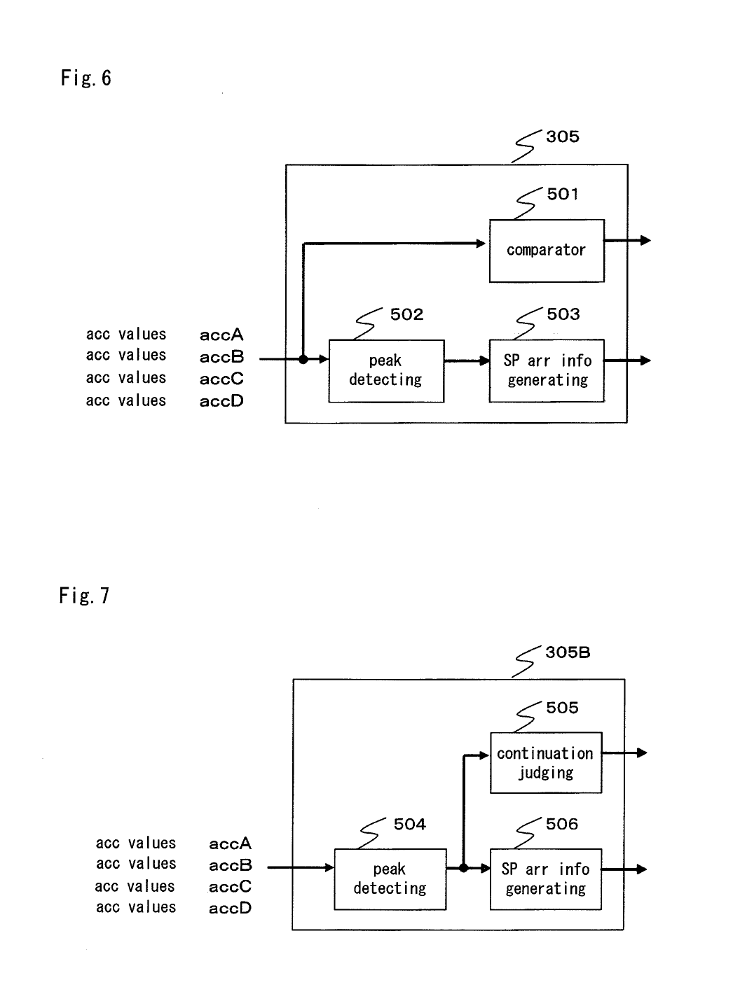

A judging unit 305 may be configured as shown in FIG. 6.

In FIG. 6, the judging unit 305, a threshold value comparator 501, a peak detecting unit 502, and an SP arrangement information generating unit 503 are shown, respectively.

The threshold value comparator 501 inputs accumulative values accA, accB, accC, and accD, and sets up a value of the SP synchronization flag to “1” when one of the accumulative values becomes greater than a predetermined threshold value.

The peak detecting unit 502 specifies a group corresponding to the maximum of the accumulative values accA, accB, accC, and accD, and outputs the specified group to the SP arrangement information generating unit 503.

The SP arrangement information generating unit 503 generates a relative-symbol number according to the group outputted from the peak detecting unit, and outputs the generated number as SP arrangement information.

For example, in FIG. 5, it is assumed that an obtained accumulative value C of carrier numbers are “3, 15, . . . ” is the maximum among accumulative values of the groups when a temporary symbol number is “n+3”. If relative-symbol numbers have been defined as shown in FIG. 2, a relative symbol of “1” is outputted when the temporary symbol number is “n+3”.

Elements of the judging unit 305 can be thus simply configured.

Like a case where a C/N (Carrier to Noise) ratio of receiving signals is low, when a correlation degree of transmitting complex symbols becomes small, all of the correlation values A, B, C, and D obtained from the correlation calculating units 303A, 303B, 303C, and 303D also become small. In such a case, time until accumulative results of correlation values becomes great enough becomes longer than a case with a higher C/N ratio. It may take a long time for one of the accumulative values accA, accB, accC, and accD to become greater than a threshold value.

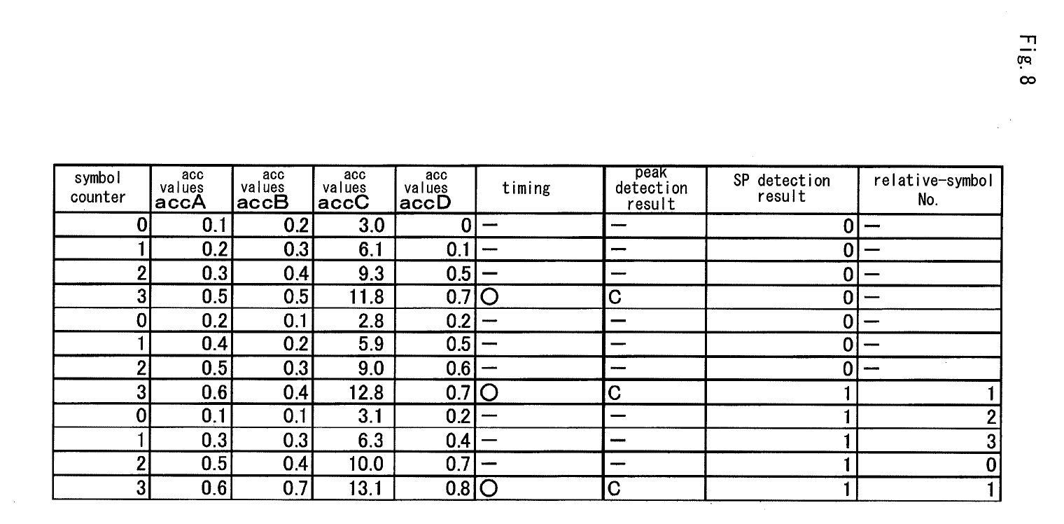

Alternatively, a judging unit 305B may detect SP signals according to the following method. FIG. 7 is a block diagram of the judging unit 305B.

In FIG. 7, the judging unit 305B, a peak detecting unit 504, a continuation judging unit 505, and an SP arrangement information generating unit 506 are shown, respectively. Referring to FIG. 8, operation thereof will now be explained.

FIG. 8 is a time chart that illustrates the operation of the judging unit 305B.

It is assumed that the SP detecting unit 106 according to this embodiment includes a symbol counter (not shown) therein, accumulative results of the accumulating units 304A, 304B, 304C, and 304D are zero cleared for every predetermined accumulative period, and then accumulating the values will be restarted.

As shown in FIG. 8, four accumulative values accA, accB, accC, and accD are inputted to the peak detecting unit 504, and it is assumed that the four accumulative values becomes greater as a value of the symbol counter becomes greater.

The peak detecting unit 504 is provided with peak detection timing that synchronizes with the accumulative period, compares the four accumulative values at the peak detection timing, and detects a group corresponding to the maximum of the four accumulative values. Now it is assumed that the accumulative period is a period of four symbols, and that the peak detection timing (See, the circle in FIG. 8) is timing at which the symbol counter in FIG. 8 has a value of “3”, thereby detecting a group of the maximum. In FIG. 8, there are three points of peak detection timing, a group of the maximum accumulative values is group C, and the peak detecting unit 504 outputs this information to the continuation judging unit 505.

The continuation judging unit 505 judges whether or not a group corresponding to the maximum accumulative value among inputted accumulative values keeps to be the same during a predetermined period. More concretely, the continuation judging unit 505 judges that SP signals have been detected and sets up an SP detection flag to “1” when a group inputted from the peak detecting unit 504 keeps to be the same during a plurality numbers of the peak detection timing. For example, it is judged that SP signals can be detected when the peak detection result indicates that the same group is the maximum during two continuous times of the peak detection timing. In this case, as shown in FIG. 8, since both of a first peak detection result of a first peak detection timing and a second peak detection result of a second peak detection timing indicate group C, the SP detection flag is changed from “0” to “1” at the second peak detection timing.

If a group inputted from the peak detecting unit 504 does not keep to be the same during a plurality numbers of the peak detection timing, it may be considered that SP signals have not been detected and the SP detection flag may be set up to “0”.

The SP arrangement information generating unit 506 may be configured like the above-mentioned SP arrangement information generating unit 503, generates a relative-symbol number corresponding to a group outputted from the peak detecting unit 504, and outputs the generated number as the SP arrangement information.

Since the judging unit 305B does not compare the accumulative values accA, accB, and accC, and accD with the predetermined threshold value, but compares the accumulative values with themselves to detect a group of the maximum accumulative value, process thereby does not depend upon absolute values of the accumulative values. The judging unit 305B judges that SP signals exist in receiving signals when a detected group of the maximum accumulative values keep being the same during a predetermined period. For this reason, configuration of the judging unit 305B is more complicated than that of the judging unit 305. On the contrary, adding simple elements to the judging unit 305 to configure the judging unit 305B enables to perform rapid judgment of SP signals with higher precision comparing with the judging unit 305 itself even when absolute values and/or accumulative values of correlation of complex symbols transmitting SP signals become small such as a case where a C/N ratio of receiving signals is low.

The above-mentioned judging unit 305B uses a first timing at which accumulative results are zero cleared and a second timing of the peak detection timing, the first and second timing being the same. The first and second timing, however, may not be the same, and the second cycle of the second timing may be longer than the first cycle of the first timing, for example. In this case, lowering an operation frequency enables to reduce power consumption of the receiver apparatus. Alternatively, with respect to the above-mentioned judging unit 305B, the second cycle of the second timing may be shorter than the first cycle of the first timing. In this case, although peak detection is performed in the middle of accumulating values, an existence judging result of OFDM signals can be obtained more quickly.

In the above explanation, the judging units 305 and 305B generate SP detection flags meaning that SP signals have been detected when accumulative values inputted from the accumulating units 304B, 304C, and 304D satisfy the predetermined condition. The judging units 305 and 305B may generate SP detection flags meaning that SP signals have not been detected when no accumulative value inputted from the accumulating units 304B, 304C, and 304D satisfies the predetermined condition.

Channel search operation using the receiver apparatus according to the present invention shown in FIG. 1 will now be explained.

The receiver apparatus according to the present invention has a feature of “when performing channel search, using a detection result of SP signals for detecting OFDM signals”.

As shown in FIG. 2, on a time-frequency plane of general OFDM signals, pilot signals (SP signals) that are criteria for demodulation are arranged at the predetermined interval. The OFDM signals have the important feature of “arranging the pilot signals thus”. If existence of the pilot signals can be detected, then it can be judged that the receiving signals are the OFDM signals. In view of the above, the receiver apparatus according to the present invention detects the pilot signals (SP signals) to detect OFDM signals, receives signals while sequentially changing the selected channel within all RF bandwidths or predetermined RF bandwidth, thereby rapidly performing channel searches while pre-detecting a receivable channel.

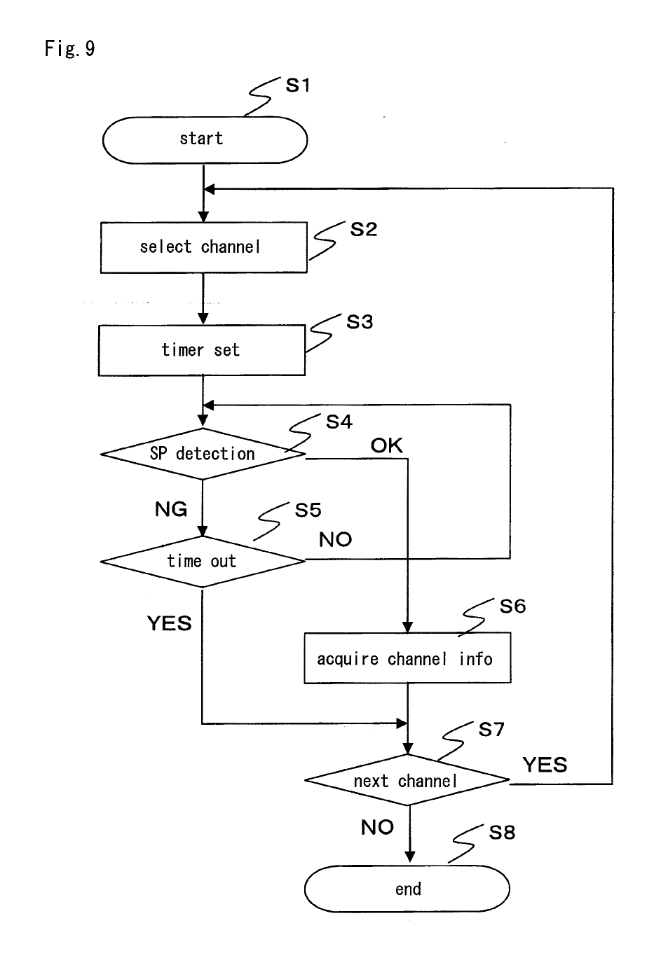

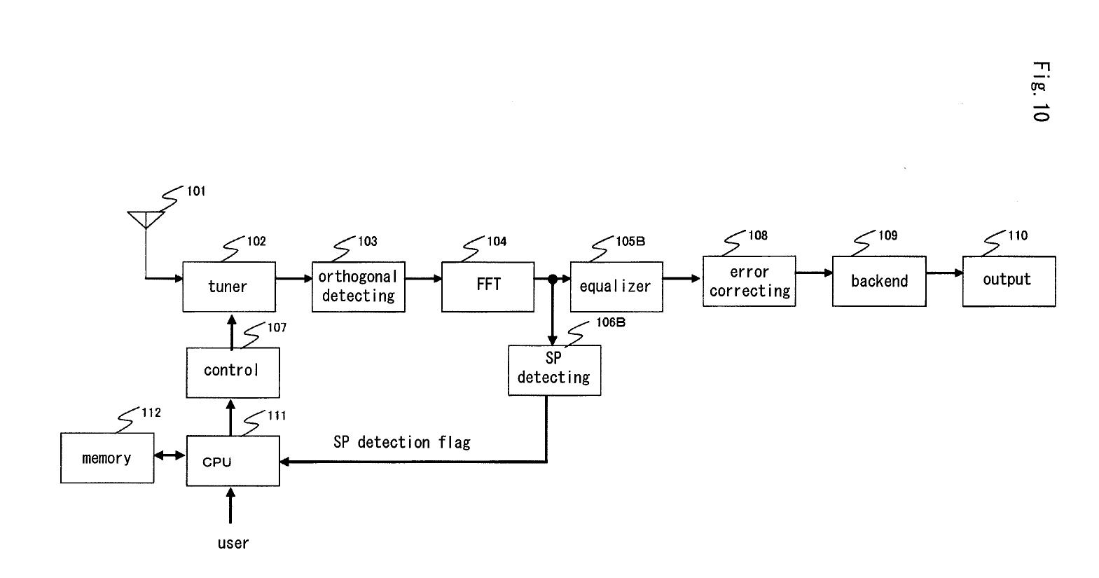

FIG. 9 is a flow chart of the operation of the channel search.

In FIG. 9, a start step S1, a channel selection step S2, a setting timer step S3, an SP detection judging step S4, a judging time out step S5, an obtaining channel information step S6, a next channel selecting step S7, and a termination step S8 are shown, respectively.

Referring to FIG. 9 and FIG. 1, the receiver apparatus according to the present invention performs a channel search as follows.

First, at the start step S1, a channel search is started. In FIG. 1, this starting is done when a user inputs an instruction to the CPU.

At the channel selection step S2, the CPU 111 in FIG. 1 instructs predetermined channel selection with a channel search, and then receiving operation will start.

At the setting timer step S3, in order to measure whether SP signals are detectable within a predetermined time out period, the CPU 111 resets the timer.

At the SP detection judging step S4, based on the SP detection flag outputted from the SP detecting unit 106 to the CPU 111, the CPU 111 watches whether or not SP signals are detected. When the SP detection flag indicates that SP signals cannot be detected (NG), process goes to the judging time out step S5. On the other hand, when the SP detection flag indicates that SP signals can be detected (O.K.), process goes to the obtaining channel information step S6.

At the judging time out step S5, the CPU 111 watches whether or not it takes a predetermined time (time out period) after the timer is reset at the step S3. If not (NO), process goes to the step S4 again. On the other hand, when it takes the predetermined time (time out period) after the timer is reset (NG), SP signals cannot be detected from the received channel within a fixed time. In this case, it is judged that receivable OFDM signals do not exist at the selected channel, or it is judged that there is no desired signal. After that, process goes to the next channel selection step S7.

At the obtaining channel information step S6, SP signals have been detected. Accordingly, it is judged that receivable OFDM signals exist in the selected receiving channel. The CPU 111 acquires various kinds of information for receiving signals, and stores the information onto the memory 112.

At the next channel selection step S7, when one or more channels to be channel searched remains (YES), process goes to the step S2 in order to select the next channel. Or, when no channel to be channel searched remains (NO), process goes to the termination step S8 in order to end the channel searches.

As mentioned above, in order to rapidly detect a channel in which OFDM signals exist with high precision, the receiver apparatus according to the present invention detects existence of SP signals.

The SP detecting method according to the present invention includes: based on the knowledge that SP signals of the fixed amplitude and phase are inserted at an interval of four symbols, using correlation values of complex symbols at the interval to detect SP signals. For this reason, it takes only time of a few symbols or dozens of symbols to finish detecting SP signals from the beginning of channel selection. On the contrary, conventional receiver apparatuses detect OFDM signals after having detected frame synchronization signals of 204 symbol periods. Namely, the receiver apparatus according to the present invention can detect OFDM signals remarkably faster than the conventional receiver apparatuses.

In Mode 3 of the ISDB-T standard, there are 468 SP signals per channel. The number of “468” is more than the sum of a number of “52” (a number of TMCC signals) and a number of “104” (a number of AC signals). With respect to receiving one segment broadcasting, there are 36 SP signals within the central segment of bandwidth. The number of “36” is also more than the sum of a number of “4” (a number of TMCC signals) and a number of “8” (a number of AC signals). These relationships mean that the method according to the present invention, which uses SP signals for detecting OFDM signals, enables to detect OFDM signals more stably than the method using TMCC signals and/or AC signals against a case where multipaths cause power of specific carriers to be reduced and/or a case where disturbance affects carriers of specific frequencies.

The receiver apparatus and the receiving method with simple arrangement and simple processes according to the present invention enable to earn effects that the conventional OFDM receiver apparatuses cannot accomplish.

### Embodiment 2

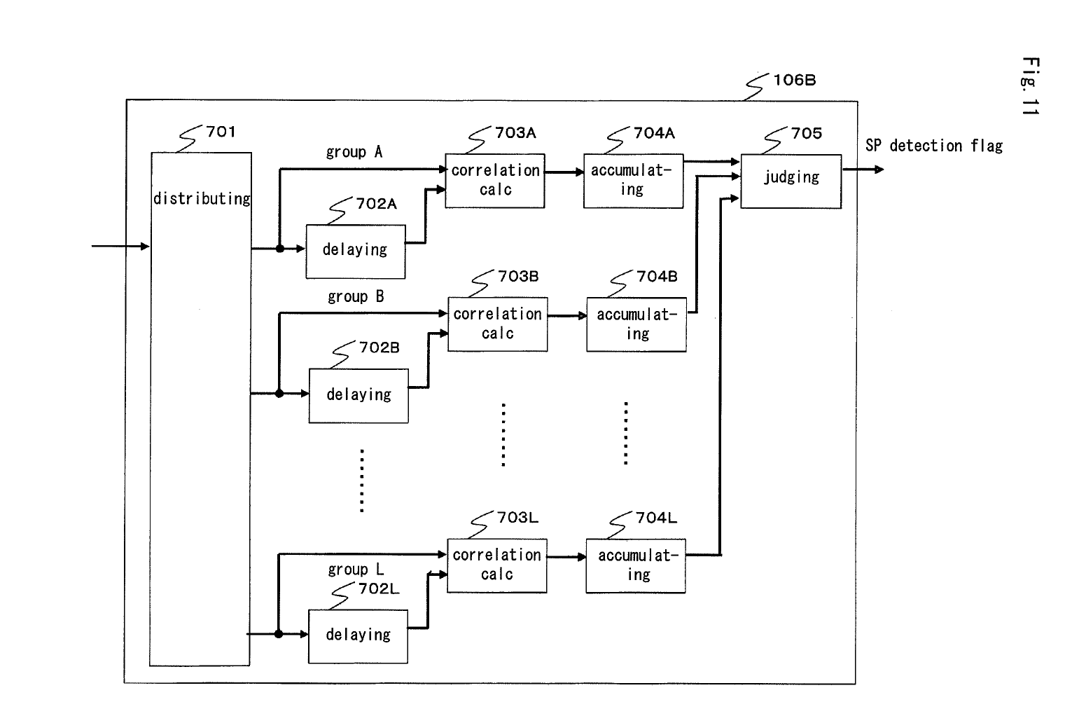

FIG. 10 is a block diagram of a receiver apparatus of Embodiment 2 according to the present invention. The receiver apparatus of FIG. 10 includes a feature of “a SP detecting unit 106B does not output SP arrangement information, but outputs only an SP detection flag”. The receiver apparatus in FIG. 10 differs from the receiver apparatus shown in FIG. 1 only with respect to the SP detecting unit 106B and an equalizer 105B. Explanation of the same elements is omitted by adding the same symbols as the FIG. 1.

In FIG. 10, the equalizer 105B and the SP detecting unit 106B are shown, respectively. Operation of each element will now be explained.

The equalizer 105B estimates the state of transmission paths based on SP signals inputted from the FFT outputting unit 104, compensates waveform distortion of the receiving signals in the estimated transmission paths (so-called “waveform equalization”), generates an equalized signal, and outputs the generated equalized signal to the error correcting unit 108.

The SP detecting unit 106B detects the existence of SP signals from OFDM signals of a frequency-domain, and outputs an SP flag to the CPU 111 as a result.

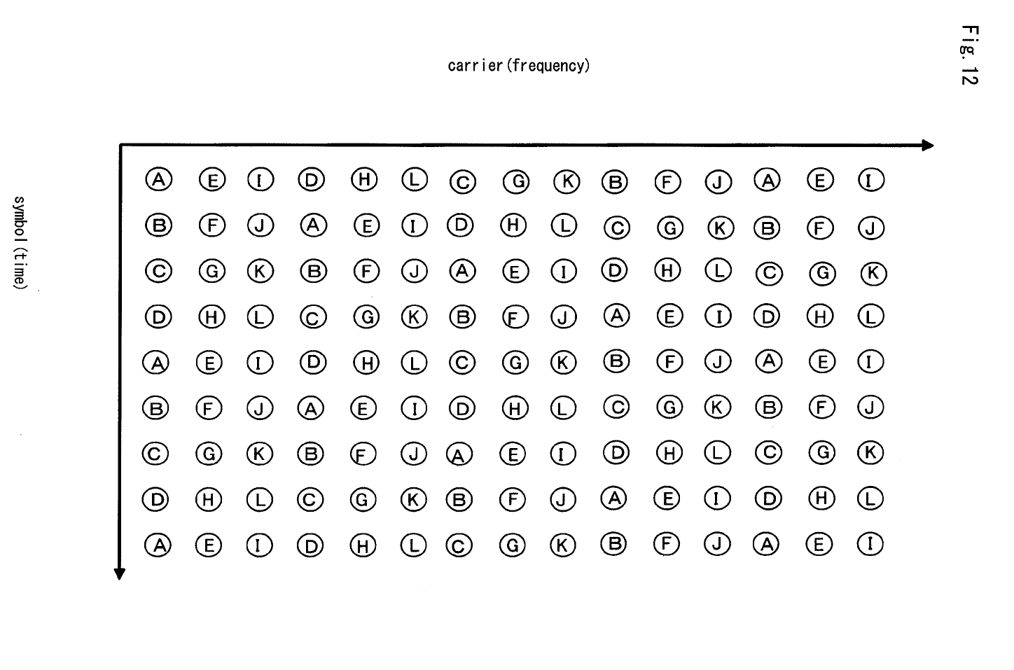

The SP detecting unit 106B may be configured as shown in FIG. 11. FIG. 11 shows configuration of the SP detecting unit 106B in Embodiment 2 according to the present invention. Not like the SP detecting unit 106 that handles four groups as shown in FIG. 3 to detect SP signals, the SP detecting unit 106B handles twelve groups.

In FIG. 11, a distributing unit 401, delaying units 402A, 402B and 402L, correlation calculating units 403A, 403B and 403L, accumulating units 404A, 404B and 404L, and a judging unit 405 are shown, respectively. Elements in FIG. 11 are almost similar to those explained in Embodiment 1. Hereinafter, difference there-between will now be mainly explained.

Immediately after beginning of receiving operation until taking frequency synchronization according to an AFC (Auto Frequency Control) and detecting a frame synchronous signal, carrier numbers and symbol numbers of receiving signals cannot be determined. In this status, the SP detecting unit 106B inputs OFDM signals of a frequency-domain as shown in FIG. 12. As shown in FIG. 12, in this status, carrier numbers of the horizontal axis and symbol numbers of the vertical axis are not detected, and it is unknown where (carrier, symbol) SP signals are inserted. It is, however, known that complex symbols belonging to one of the twelve groups “A, B, C, D, E, F, H, I, J, K, L” transmit the SP signals. The group “A” is a group of complex symbols labeled “A” in FIG. 12. The other groups are similar to this.

As clear from FIG. 2, in one certain symbol, an inserted interval of SP signals in a carrier direction is composed of twelve carriers. The number “12” of the groups in this Embodiment is determined according to the twelve carriers, one of which SP signals are inserted therein. Since carriers with one of carrier numbers “0, 1, . . . , and 11” transmit SP signals, it is preferable to provide with twelve groups to detect the existence of the SP signals when carriers transmitting the SP signals are unknown.

The distributing unit 701 extracts complex symbols belonging to group A from inputted OFDM signals of a frequency-domain, and outputs the extracted complex symbols to the delaying unit 702A and the correlation calculating unit 703A. Similarly, the distributing unit 701 extracts complex symbols belonging to groups B, C, . . . , and L from inputted OFDM signals of the frequency-domain, and outputs the extracted complex symbols to the delaying units 702B, 702C, . . . , and 702L and the correlation calculating units 703B, 703C, . . . , and 703L. Showing delaying units and correlation calculating units corresponding to groups C, . . . , and K in FIG. 11 is omitted.

The delaying units 702A, 702B, 702C, . . . , and 702L delay inputted complex symbols for four symbols of the inserted interval of SP signals, and output the delayed complex symbols to corresponding correlation calculating units 703A, 703B, . . . , and 703L, respectively.

The correlation calculating unit 703A calculates a correlation value between a complex symbol inputted from the distributing unit 701 and a complex symbol obtained from the delaying unit 702A to output a calculation result to the accumulating unit 704A. Similarly, the correlation calculating units 703B, 703C, . . . , and 703D calculate correlation values between complex symbols inputted from the distributing unit 701 and complex symbol obtained from the delaying units 702B, 702C, . . . , and 702D to output calculation results to the accumulating units 704B, 704C, . . . , and 704L, respectively. Showing accumulating units corresponding to groups C, . . . , and K in FIG. 11 is omitted.

The accumulating unit 704A accumulates correlation values inputted from the correlation calculating unit 703A to output an accumulated result to the judging unit 705 as an accumulated value. Similarly, the accumulating units 704B, . . . , and 704L accumulate inputted correlation values to output accumulated results to the judging unit 705 as accumulated values, respectively.

The delaying units, the correlation calculating units, and the accumulating units may be configured as the same as explained in Embodiment 1, and the operation of these units may be also the same as Embodiment 1.

The judging unit 305 outputs an SP detection flag meaning that SP signals are detected to the control unit 107 when the accumulative values inputted from the accumulating units 704A, 704B, . . . , and 704L satisfy a predetermined condition.

The judging method of the judging unit 705 for judging whether or not SP signals are detected may be as the same as explained in Embodiment 1. The judging unit 705 may be configured omitting the SP arrangement information generating unit 503 of the judging unit 305 in FIG. 6 or the SP arrangement information generating unit 506 in FIG. 7.

Similar to the judging unit 305 in FIG. 6, it may be judged that SP signals exist in receiving signals when one of accumulative values inputted from the accumulating units 704A, 704B, . . . , and 704L is greater than a predetermined threshold value.

Alternatively, similar to the judging unit 305B in FIG. 7, relatively comparing between accumulative values inputted from the accumulating units 704A, 704B, . . . , and 704L to detect a group of the maximum accumulative value. It may be judged that SP signals exist in receiving signals when the detected group keeps being the same during a predetermined period.

The SP detecting unit 106B shown in FIG. 11 enables to start correlation calculation operation between four symbols of the inserted interval of the SP signals without specifying carriers transmitting SP signals even when the AFC has not yet finished removing frequency errors, that is, the carrier numbers and symbol numbers are not detected and it is unknown where (carrier, symbol) SP signals are inserted. According to the SP detecting unit, correlation indexes between four symbols of the inserted interval of SP signals are obtained with respect to all carriers, thereby enabling to suitably detect the SP signals. For this reason, detecting the SP signals at a speed higher than the arrangement of the SP synchronous detecting unit 106 in FIG. 1 can be performed.

In addition, in Embodiment 1 and Embodiment 2, explanation of calculating correlation values between SP signals transmitted by the same carrier when calculating correlation values of the SP signals is made. Correlation, however, between SP signals transmitted by carriers different from each other may be performed, instead. For example, a first correlation value between a first complex symbol at the position of a symbol number “0” and a carrier number “0” and a second complex symbol at the position of a symbol number “0” and a carrier number “12” may be calculated, or a second correlation value between the first complex symbol at the position of a symbol number “0” and a carrier number “0” and a third complex symbol at the position of a symbol number “1” and a carrier number “3” may be calculated. In these cases, judgment precision when receiving signals while moving at a high speed is improved.

When phases of SP signals are determined for every carrier in the ISDB-T standard or the like, before calculating correlation values between complex symbols belonging to carriers different from each other, phase amendment such that amended carriers have the same phase should be suitably performed on the carriers. The scope of the present invention includes not only a case where such phase amendment is performed but also another case where such phase amendment is not performed. For example, in the ISDB-T standard, a phase of an SP signal is determined to be either of “0” or “pi” for every carrier. When positions of carriers transmitting SP signals as explained in Embodiment 1 are known, calculating a correlation may be performed after having amended phases of two complex symbols to be calculated the correlation value thereof.

Alternatively, a method for calculating a correlation value of complex symbols of carrier numbers differing from each other may include: transforming one input into a complex conjugate; performing complex multiplication of the complex conjugate and the other input to output a complex multiplication result; and multiplying the complex multiplication result by itself. In the ISDB-T standard, phases of SP signals are different from each other for every carrier, which are either of “0” or “pi”. The multiplying the complex multiplication result by itself enables to solve uncertainty that a pair of complex symbols, which are used for calculating a correlation value of a pair of complex symbols, may have an anti-phase or the same phase, thereby enabling to calculate an appropriate correlation value.

As discussed above, the receiver apparatus according to the present invention detects SP signals to judge whether or not the receiving signals are OFDM signals. In the ISDB-T standard, one frame is composed of 204 symbols, and frame synchronous signals for identifying every frame are transmitted with sixteen symbols among the 204 symbols. It takes at least time of one frame or more to detect a frame synchronous signal, if judging whether or not OFDM signals exist must be performed after having detected the frame synchronous signal. On the contrary, according to the receiver apparatus of the present invention, it takes only time of a few symbols or dozens of symbols, thereby enabling to rapidly detect OFDM signals. This is because the receiver apparatus detects SP signals transmitted in a cycle of four symbols.

Since OFDM signals are detected based on SP signals more than TMCC carriers and AC carriers of the ISDB-T standard, detection with high precision can be performed even in a receiving status where transmission paths are inferior.

In the above, explanation is made using an example of receiving OFDM signals in the ISDB-T standard. The receiver apparatus and the receiving method according to the present invention can apply not only OFDM signals based on the ISDB-T standard but also OFDM signals based on standards other than the ISDB-T standard. The above explanation uses an example of OFDM signals having the first inserted interval of four SP signals (pilot signals) in the symbol direction and the second inserted interval of twelve SP signals in the carrier direction. The scope of the present invention is not limited according to the inserted intervals of pilot signals. The present invention is applicable to transmission system using an OFDM method with pilot signals whose amplitude and phase are determined, the pilot signals being inserted at a predetermined symbol interval in the symbol direction and/or at a predetermined carrier interval in the carrier direction, for example in the DVB-T standard, the DVB-T2 standard, or the like.

The receiver apparatuses and the receiving methods explained in Embodiments 1 and 2 are mere examples for explaining the present invention. The present invention includes modification and reconstruction thereof without deviating from the scope thereof. Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

### INDUSTRIAL APPLICABILITY

The receiver apparatus according to the present invention is, for example, suitably applicable for receiving digital terrestrial television services using an OFDM method in Japan, Europe and South America, and for receiving signals of wireless LAN system using the OFDM method, or the like.

1. A receiver apparatus capable of receiving OFDM signals in which pilot signals with predetermined amplitude and a predetermined phase are inserted at a predetermined time interval or a frequency interval to be transmitted, the receiver apparatus comprising:
a Fourier transforming unit operable to transform signals inputted to the receiver apparatus to frequency-domain signals, thereby outputting the transformed signals on a complex symbol-by-complex symbol basis;
an index calculating unit operable to calculate an index indicating a correlation between complex symbols in a respective one of a plurality of groups, each of the plurality of groups being a set of a plurality of complex symbols separated from each other by an interval in which a pilot signal is inserted, the group being selected such that the complex symbols constituting the groups differing from each other;
a judging unit operable to judge, based on the calculated index for each group, whether or not any index satisfying a predetermined condition is existent, thereby outputting a result of the judgment; and
a processing unit operable to judge whether or not the signals inputted to the receiver apparatus are OFDM signals according to the result of the judgment of said judging unit.

2. The receiver apparatus as defined in claim 1, wherein said processing unit judges whether or not any index greater than a predetermined value is existent among indexes calculated for each group by said index calculating unit, thereby outputting the result of the judgment.

3. The receiver apparatus as defined in claim 1, wherein said processing unit judges that the signals inputted to the receiver apparatus are not OFDM signals according to the result of the judgment of said judging unit.

4. The receiver apparatus capable of receiving OFDM signals in which pilot signals with predetermined amplitude and a predetermined phase are inserted at a predetermined time interval or a frequency interval to be transmitted, the receiver apparatus comprising:
a Fourier transforming unit operable to transform signals inputted to the receiver apparatus to frequency-domain signals, thereby outputting the transformed signals on a complex symbol-by-complex symbol basis;
an index calculating unit operable to calculate an index indicating a correlation between complex symbols in a respective one of a plurality of groups, each of the plurality of groups being a set of a plurality of complex symbols separated from each other by an interval in which a pilot signal is inserted, the group being selected such that the complex symbols constituting the groups differing from each other; and
a judging unit operable to judge, based on the calculated indexes for each group, whether or not an index corresponding to the same group being successively the greatest a plurality of times is existent among indexes calculated for each group according to a predetermined judgment timing.

5. The receiver apparatus as defined in claim 4, further comprising a processing unit, wherein said processing unit judges that the signals inputted to the receiver apparatus are not OFDM signals according to the result of the judgment of said judging unit.

6. The receiver apparatus as defined in claim 4, further comprising an equalizer, wherein:
said judging unit detects insertion timing of the pilot signals based on the calculated indexes for each group by said index calculating unit; and
said equalizer performs waveform equalization of the frequency-domain signal based on the insertion timing of the pilot signals.

7. A receiver apparatus capable of receiving OFDM signals in which pilot signals with predetermined amplitude and a predetermined phase are inserted at a predetermined time interval or a frequency interval to be transmitted, the receiver apparatus comprising:
a selector operable to select a specified channel from signals inputted to the receiver apparatus to output signals of the selected channel;
a Fourier transforming unit operable to transform the signals outputted by said selector to frequency-domain signals, thereby outputting the converted signals on a complex symbol-by-complex symbol basis;
an index calculating unit operable to calculate an index indicating a correlation between complex symbols in a respective one of a plurality of groups, each of the plurality of groups being a set of a plurality of complex symbols separated from each other by an interval in which a pilot signal is inserted, the group being selected such that the complex symbols constituting the groups differing from each other;
a judging unit operable to judge, based on the calculated index for each group, whether or not any index satisfying a predetermined condition is existent, thereby outputting a result of the judgment; and
a processing unit operable to change the channel selected by said selector when it is not judged within a predetermined period that any index and/or any group satisfying a predetermined condition are/is existent.

8. The receiver apparatus as defined in claim 7, further comprising a storing unit, wherein:
said processing unit acquires channel information selected by said selector, outputs the information to said storing unit, and changes the channel selected by said selector when it is judged within the predetermined period that the index satisfying the predetermined condition is existent based on the result of judgment of said judging unit; and
said storing unit stores the channel information outputted from said processing unit.

9. The receiver apparatus as defined in claim 1, wherein said index calculating unit starts to calculate the index indicating the correlation between the complex symbols in the respective one of the plurality of groups before detecting a position of a carrier transmitting the pilot signal.

10. The receiver apparatus as defined in claim 4, wherein said index calculating unit starts to calculate the index indicating the correlation between the complex symbols in the respective one of the plurality of groups before detecting a position of a carrier transmitting the pilot signal.

11. The receiver apparatus as defined in claim 7, wherein said index calculating unit starts to calculate the index indicating the correlation between the complex symbols in the respective one of the plurality of groups before detecting a position of a carrier transmitting the pilot signal.

12. The receiver apparatus as defined in claim 1, wherein:
each of the plurality of groups is the set of the plurality of complex symbols separated from each other by the interval in which the pilot signal is inserted, the group being selected such that the complex symbols constituting the groups differing from each other; and
said index calculating unit calculates an index indicating a correlation between complex symbols for each group with respect to a plurality of groups not greater than a number of complex symbols corresponding to the interval in which the pilot signal is inserted in a carrier direction.

13. The receiver apparatus as defined in claim 4, wherein:
each of the plurality of groups is the set of the plurality of complex symbols separated from each other by the interval in which the pilot signal is inserted, the group being selected such that the complex symbols constituting the groups differing from each other; and
said index calculating unit calculates an index indicating a correlation between complex symbols for each group with respect to a plurality of groups not greater than a number of complex symbols corresponding to the interval in which the pilot signal is inserted in a carrier direction.

14. The receiver apparatus as defined in claim 7, wherein:
each of the plurality of groups is the set of the plurality of complex symbols separated from each other by the interval in which the pilot signal is inserted, the group being selected such that the complex symbols constituting the groups differing from each other; and
said index calculating unit calculates an index indicating a correlation between complex symbols for each group with respect to a plurality of groups not greater than a number of complex symbols corresponding to the interval in which the pilot signal is inserted in a carrier direction.

15. The receiver apparatus as defined in claim 1, wherein said index calculating unit performs complex conjugate multiplication with respect to predetermined two complex symbols to obtain a result thereof, multiplies the result by itself to obtain a square result, and calculates the index indicating the correlation between the complex symbols for each group based on the square result.

16. A receiving method for receiving OFDM signals in which pilot signals with a predetermined amplitude and a predetermined phase are inserted at a predetermined time interval or a frequency interval to be transmitted, the receiving method comprising:
Fourier transforming inputted signals to frequency-domain signals, thereby outputting the transformed signals on a complex symbol-by-complex symbol basis;
calculating an index indicating a correlation between complex symbols in a respective one of a plurality of groups, each of the plurality of groups being a set of a plurality of complex symbols separated from each other by an interval in which a pilot signal is inserted, the group being selected such that the complex symbols constituting the groups differing from each other;
judging, based on the calculated index for each group, whether or not any index satisfying a predetermined condition is existent, thereby outputting a result of the judgment; and
judging whether or not the inputted signals are OFDM signals according to the result of said judging.

17. A receiving method for receiving OFDM signals in which pilot signals with a predetermined amplitude and a predetermined phase are inserted at a predetermined time interval or a frequency interval to be transmitted, the receiving method comprising:
Fourier transforming inputted signals to frequency-domain signals, thereby outputting the transformed signals on a complex symbol-by-complex symbol basis;
calculating an index indicating a correlation between complex symbols in a respective one of a plurality of groups, each of the plurality of groups being a set of a plurality of complex symbols separated from each other by an interval in which a pilot signal is inserted, the group being selected such that the complex symbols constituting the groups differing from each other; and
judging, based on the calculated indexes for each group, whether or not the greatest index corresponding to the same group is existent among indexes successively calculated a plurality of times for each group according to a predetermined timing.

18. A receiving method for receiving OFDM signals in which pilot signals with predetermined amplitude and a predetermined phase are inserted at a predetermined time interval or a frequency interval to be transmitted, the receiver apparatus comprising:
selecting a specified channel from inputted signals to output signals of the specified channel;
Fourier transforming the outputted signals to frequency-domain signals, thereby outputting the converted signals on a complex symbol-by-complex symbol basis;
calculating an index indicating a correlation between complex symbols in a respective one of a plurality of groups, each of the plurality of groups being a set of a plurality of complex symbols separated from each other by an interval in which a pilot signal is inserted, the group being selected such that the complex symbols constituting the groups differing from each other;
judging, based on the calculated index for each group, whether or not any index satisfying a predetermined condition is existent, thereby outputting a result of the judgment; and
changing the selected channel in said selecting when it is not judged within a predetermined period that any index and/or any group satisfying a predetermined condition are/is existent.
